(19) United States
(12) Patent Application Publication
(10) Pub. No.: US 2022/0060072 A1
(43) Pub. Date: Feb. 24, 2022

(54) ROTOR DEVICE FOR AN ELECTRIC MACHINE AND ELECTRIC MACHINE

(71) Applicant: JHEECO E-DRIVE AG, St. Gallen (CH)

(72) Inventor: Markus MICHAEL, Altstätten (CH)

(21) Appl. No.: 17/312,815

(22) PCT Filed: Dec. 11, 2019
(86) PCT No.: PCT/EP2019/084708

§ 371 Date: Jun. 10, 2021

(30) Foreign Application Priority Data
Dec. 12, 2018 (DE) 10 2018 221 569.3

(51) Int. Cl. H02K 1/32

(52) U.S. Cl. CPC H02K 1/32

(57) ABSTRACT

The present invention relates to a rotor device for an electric machine, comprising a rotor having a rotor shaft and a rotor core, the rotor shaft being designed, at least in portions, as a hollow shaft having an inner wall, a fluid lance for cooling the inside of the rotor being introduced into the hollow shaft, and the inner wall of the hollow shaft being equipped with an impact protrusion. The invention also relates to an electric machine having a rotor device according to the invention.

The present invention relates to a rotor device for an electric machine, in particular for an electric motor according to the preamble of claim 1 and an electric machine, in particular an electric motor according to claim 15.

An electric machine usually has a rotor (armature) and a stator (field), wherein the rotor is mounted for rotation relative to the stator about a common longitudinal axis. The rotor can be designed as a hollow cylindrical body (hollow shaft).

In order to protect rotors of electric machines, in particular their windings, rotor shafts or rotor lamination core, from thermal overload, they are often cooled by means of cooling the inside of the rotor, in which a cooling fluid flows through a hollow shaft.

For uniform cooling of the shaft, it has proved preferable not to allow cooling fluid to flow through the shaft in one direction, but to apply cooling fluid in a center-symmetrical manner and discharge it evenly to both sides.

For the center-symmetrical introduction of cooling fluid, fluid lances which co-rotate with the hollow shaft and which do not co-rotate relative to the hollow shaft, i.e. which are stationary, are known from the state of the art. Fluid lances are hollow bodies positioned in hollow shafts which, starting from an axial end of the hollow shaft, protrude into the hollow shaft and are adapted to transport a fluid from an axial end of the fluid lance to an outlet opening at the opposite end of the fluid lance, at which the fluid leaves the fluid lance in a directed or undirected manner and impacts on an inner wall of the hollow shaft. A co-rotating fluid lance is shown, for example, in WO2017214232A1 or DE102013020324A1. A stationary fluid lance is shown, for example, in DE102016004931A1.

Such a rotor device, comprising a rotor and a fluid lance, is in need of improvement, especially if the rotor is installed in an electric motor of a vehicle. Here, dynamic loads, such as cornering of the vehicle, have an influence on the exit of the cooling fluid from the fluid lance. If this cooling fluid flow is deflected in an unfavorable manner, this can result in a reduction in the cooling effect.

The present invention starts here and makes it its object to provide an improved rotor device, in particular to provide a rotor device the cooling of which is independent or at least more independent of its position in space or dynamic influences.

According to the invention, this problem is solved by a rotor device having the characterizing features of claim 1. Due to the fact that an inner wall of the hollow shaft is equipped with an impact protrusion, a cooling fluid flow of a cooling lance directed onto the impact protrusion can be divided in a predetermined manner and insofar be directed onto predetermined paths within the hollow shaft. In this context, an impact protrusion is to be understood as an inwardly directed geometric elevation relative to the inner wall of the hollow shaft, in particular at the axial height of an outlet opening of a cooling fluid lance.

Further preferred configurations of the proposed invention result in particular from the features of the dependent claims. The subject matter or features of the various claims can in principle be arbitrarily combined with one another.

In a preferred configuration of the invention, it can be provided that the fluid lance is equipped with a radial fluid outlet opening, preferably a conical bore, wherein the fluid outlet opening is directed towards the impact protrusion. This allows the cooling fluid flow to be designed and directed in a targeted manner. The radial fluid outlet opening ensures that the emerging cooling fluid jet is always directed towards the impact protrusion, wherein the conical bore can ensure that the cooling fluid jet is fanned out somewhat. This can further supportively ensure that the cooling fluid jet hits the impact protrusion even if, for example, the cooling fluid jet should be deflected by movements of the rotor shaft device in space. This allows an almost center-symmetrical distribution of the cooling fluid flow on both sides of the hollow shaft, wherein the difference in the cooling fluid flow volume on both sides is less than 10%.

In a further preferred configuration of the invention, it can be provided that the fluid lance is a stationary fluid lance. A disadvantage of co-rotating lances is that the cooling fluid undergoes a rotational component of motion through the fluid lance itself even before impacting the inner circumferential surface so that the relative speed between the fluid and the fluid impact point is low. The impact point of the fluid on the inner circumferential surface is static; it does not move. Stationary fluid lances, on the other hand, are preferable because the speed difference between the oil and the oil impact point is higher. The impact point is dynamic and sweeps the entire inner circumference of the rotor shaft. This can improve the cooling performance.

In a further preferred configuration of the invention, it may be provided that the impact protrusion divides the inner wall into a first inner wall section and a second inner wall section. The cooling fluid, which has been divided accordingly by the impact protrusion, flows over the resulting inner wall sections.

In a further preferred configuration of the invention, it may be provided that a first fluid outflow opening is arranged in the first inner wall section and a second fluid outflow opening is arranged in the second inner wall section. The cooling fluid flows out via the fluid outflow openings. Preferably, the fluid outflow openings are spaced as far as possible from the impact protrusion so that the cooling fluid can travel a correspondingly long distance and a most extensive heat exchange can take place. The fluid outlet openings can be arranged to direct and/or spray the cooling fluid in the direction of a rotor end face or a winding head of a stator.

In a further preferred configuration of the invention, it can be provided that the rotor shaft is designed as an assembled and/or rotationally welded rotor shaft comprising at least two parts, in particular a first rotor half-shaft and a second rotor half-shaft. This can, for example, facilitate the introduction or also shaping of the impact protrusion in the center of the rotor shaft, for example if the impact protrusion is introduced upstream of the rotor half-shafts are connected.

In a further preferred configuration of the invention, it can be provided that the inner wall of the rotor shaft is provided with shaft shoulders, in particular with a first shaft shoulder between the impact protrusion and the first fluid outflow opening, preferably directly upstream of the first fluid outflow opening, and a second shaft shoulder between the impact protrusion and the second fluid outflow opening, preferably directly upstream of the second fluid outflow opening. As a result, the hollow shaft forms a bathtub between the impact protrusion and the respective fluid outflow opening. The shaft shoulders act as a retaining dam for the cooling fluid. The shaft shoulders allow the cooling fluid to be dammed up to a certain extent. The thickness of the fluid film can be adjusted by the height of the shaft shoulders above the inner wall. Furthermore, it is thus possible to delay the flow time of the cooling fluid so that the cooling fluid is prevented from flowing off too quickly and the heat absorption capacity of the cooling fluid can be better utilized.

It is conceivable and possible to use a hollow rotor shaft with shaft shoulders upstream of the outlet openings independently of the use of an impact protrusion for fluid conduction. The impact protrusion could be omitted without having to dispense with the advantages resulting from the “bathtub shape”, see above. The bathtub then extends between a first and a second shaft shoulder.

Preferably, a further shaft shoulder follows downstream of the first outlet opening, preferably downstream of the first and second outlet openings, as seen in the direction of flow of the cooling fluid. This prevents cooling fluid from entering unintended regions of the hollow shaft and prevents overheating of stagnant fluid, for example.

In a further preferred configuration of the invention, it can be provided that the first inner wall section and/or the second inner wall section is structured, in particular with axially extending straight or spiral ribs, a microstructuring by sandblasting and/or small craters. The structuring basically has a surface-enlarging effect so that improved heat exchange is made possible. The channels defined by the ribs are designed, in particular in a technically preferred manner, in a spiral shape or, in a production-related preferred manner, in a straight line. Spiral-shaped channels have the advantage that the cooling fluid film is accelerated by the rotation axially outwards in the direction of the fluid outlet openings and thus, a defined fluid conveyance is created so that stagnation of oil is effectively avoided. In the case of straight channels or smooth inner walls, displacement occurs primarily as a result of the centrifugally induced effort to form a fluid film that is as thin-walled and uniform as possible.

In a further preferred configuration of the invention, it can be provided that the structuring, in particular the ribs, start at an axial distance from the impact protrusion at which the fluid film has reached >=90% of the shaft circumferential speed, and in particular that the ribs are designed to be uniformly high or to rise in the direction of the respective rotor shaft end. The rib structures preferably start at an axial distance from the impact protrusion at which the fluid film has reached as far as possible (e.g. >=90% of the) shaft circumferential speed so that a sufficient equalization of the relative tangential speed between fluid and wall surface (inner wall of the hollow shaft) has taken place. The ribs can be of uniform height or can be designed to rise axially outwards, thus, in the direction of the respective rotor shaft end, i.e. the groove depth increases. Uniformly rising ribs can start axially closer to the impact protrusion, where there is still a greater difference between shaft circumferential speed and fluid film circumferential speed. Because of the longer distance, the fluid film then spills from one groove into the next in a thermally preferred manner until the relative speed has adjusted as far as possible. The channels defined by the ribs are configured, in particular, technically preferred, spiral-shaped or, production-related preferred, straight. Spiral-shaped channels have the advantage that the cooling fluid film is accelerated by the rotation, resulting in a defined fluid conveyance so that stagnation of cooling fluid is effectively avoided. In the case of straight channels or smooth inner walls, displacement occurs primarily through the effort to form a fluid film that is as thin-walled and uniform as possible.

In a further preferred configuration of the invention, it can be provided that a fluidic bypass (equalization channel) is provided between the first inner wall section and the second inner wall section, in particular the resulting trough-shaped structure consisting of shaft shoulder, inner wall and impact protrusion on the one hand and impact protrusion, inner wall and shaft shoulder on the other hand. This allows an initial uneven distribution of cooling fluid to be compensated for, since the cooling fluid strives to form a uniformly thick fluid film due to the rotation-related circumferential forces.

In a further preferred configuration of the invention, it can be provided that the fluidic bypass is formed by grooves in the rotor shaft or an annular impact protrusion designed as a separate part, in particular a part provided with axial external grooves. A fluidic bypass designed in such a way is easy to manufacture in terms of production technology.

In a further preferred configuration of the invention, it can be provided that the impact protrusion is provided with radially extending channels, wherein the channels end in particular in the fluidic bypass. In this way, “stagnation” of the fluid below the impact protrusion in the fluidic bypass can be avoided. A portion of the cooling fluid sprayed onto the impact protrusion can enter directly into the radially extending channels and thereby reach the respective inner wall sections via the fluidic bypass.

In particular, the radially extending channels can also be in the form of a continuous radial gap. In a further preferred configuration of the invention, it can be provided that the impact protrusion is formed in one piece with the rotor shaft or as a separate part, in particular as a ring made of a material with good thermal conductivity, preferably aluminum or copper. A one-piece configuration with the rotor shaft is particularly suitable in connection with a two-piece rotor shaft, since a central impact protrusion can be easily formed here in terms of production technology. A separate configuration allows in particular a selection of materials for the impact protrusion which may differ from the material of the rotor shaft—usually steel—in particular with regard to their thermal conductivity.

In a further preferred configuration of the invention, it can be provided that the impact protrusion has a rising flank, a peak, and a descending flank in the axial direction. Alternatively, the impact protrusion has a rising flank, a first peak, a trough, a second peak, and a descending flank. In particular, the second variant is able to “catch” the fluid jet even better if deviations occur due to dynamic effects. This shape of the impact protrusion also distributes the impinging cooling fluid approximately evenly to both sides, even in the case of non-centered impact.

A further object of the present invention is to provide an improved electric machine, in particular to propose an electric machine, where cooling of the inside of the rotor is less susceptible to the position of the electric machine in space. Generally, the electric machine is installed in a motor vehicle. It is intended to ensure the most uniform possible distribution of cooling fluid in all driving situations, in particular in the event of tilting, centrifugal forces during cornering, etc.

According to the invention, this problem is solved by an electric machine having the characterizing features of claim 15. Due to the fact that the electric machine has a rotor device according to at least one of the preceding claims, the advantages of the rotor device outlined above can be made usable for the electric motor.

Further features and advantages of the present invention will become apparent from the following description of preferred embodiments with reference to the accompanying Figures. Therein

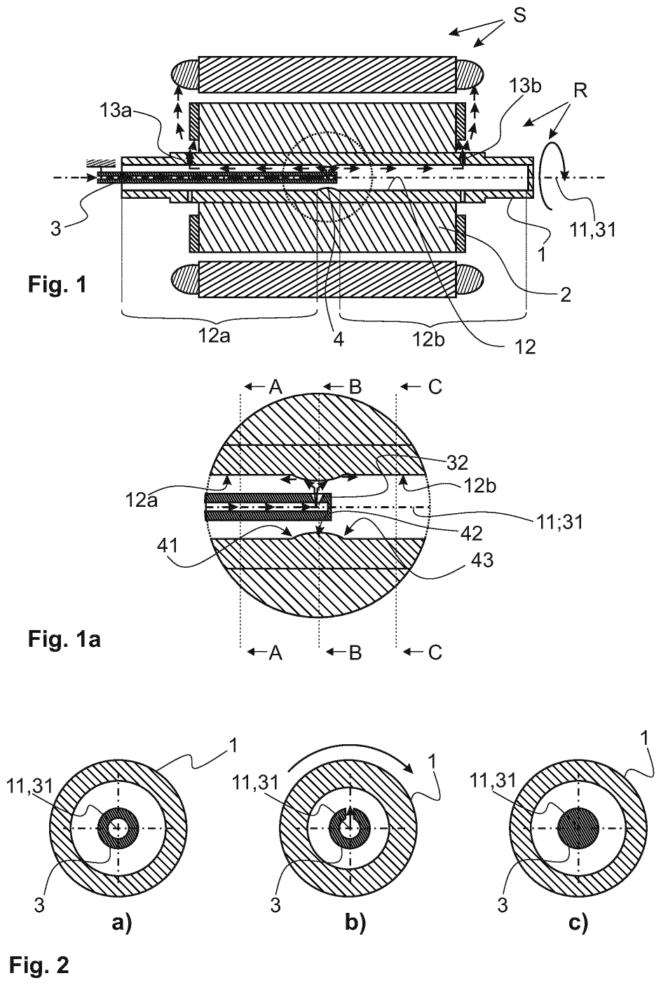

FIG. 1 shows an electric machine according to the invention with a rotor device according to the invention in a sectional schematic view;

FIG. 1a shows an enlarged section of FIG. 1;

FIG. 2a)-c) shows cross-sectional views through the rotor shaft according to sections A to C of FIG. 1a;

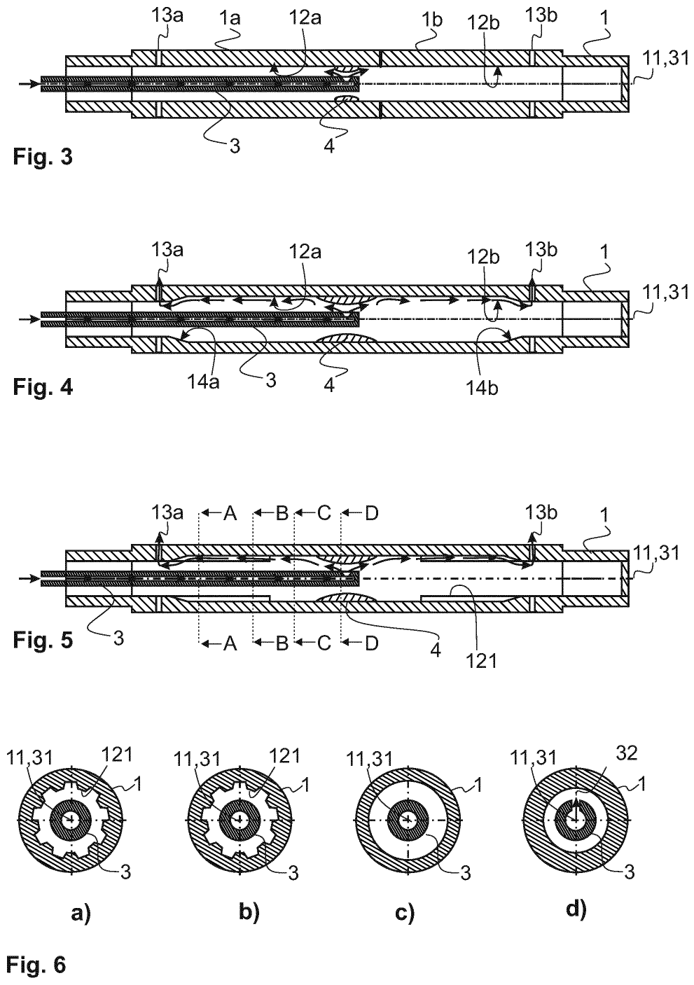

FIG. 3 shows a rotor shaft with fluid lance of a rotor device according to the invention with an indicated flow path of the cooling fluid;

FIG. 4 shows a variant of a rotor shaft with fluid lance of a rotor device according to the invention with an indicated flow path of the cooling fluid;

FIG. 5 shows a variant of a rotor shaft with fluid lance of a rotor device according to the invention with an indicated flow path of the cooling fluid;

FIG. 6a)-d) shows cross-sectional views through the rotor shaft according to sections A to D of FIG. 5;

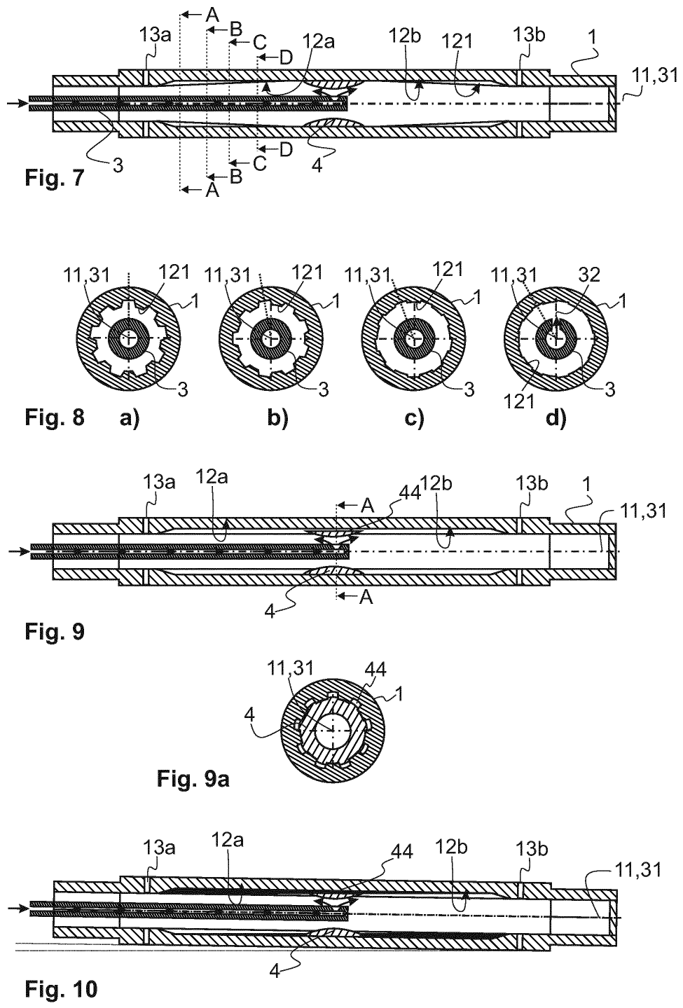

FIG. 7 shows a variant of a rotor shaft with fluid lance of a rotor device according to the invention with an indicated flow path of the cooling fluid;

FIG. 8a)-d) shows cross-sectional views through the rotor shaft according to sections A to D of FIG. 7;

FIG. 9 shows a variant of a rotor shaft with fluid lance of a rotor device according to the invention with an indicated flow path of the cooling fluid;

FIG. 9a shows a cross-sectional view through the rotor shaft according to section A of FIG. 9;

FIG. 10 shows the rotor shaft with fluid lance of a rotor device according to the invention with an indicated flow path of the cooling fluid from FIG. 9 in a tilted position;

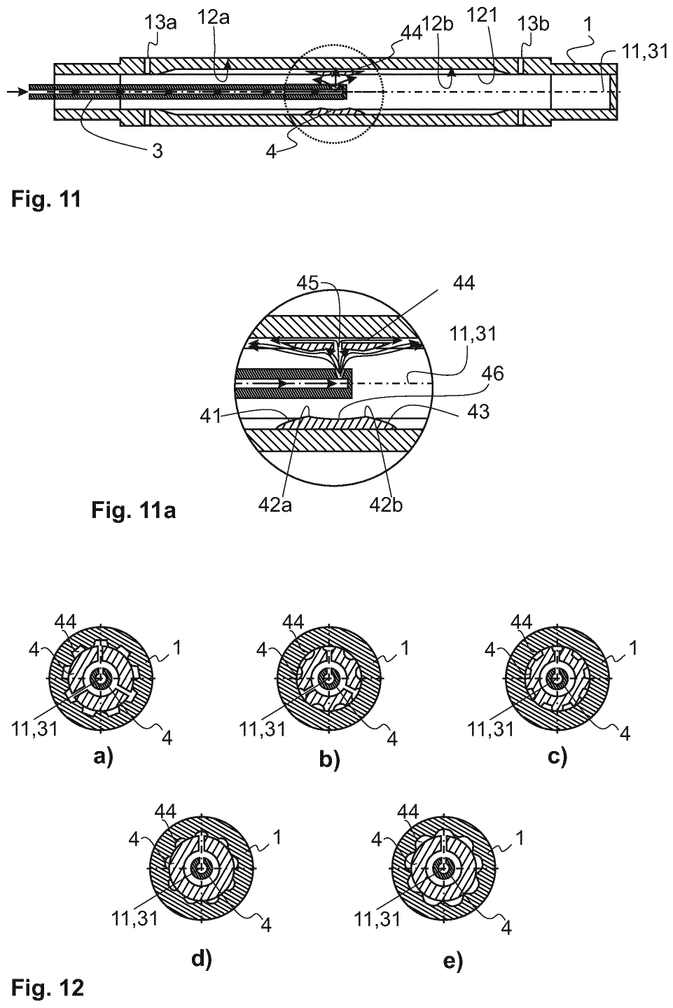

FIG. 11 shows a variant of a rotor shaft with fluid lance of a rotor device according to the invention with an indicated flow path of the cooling fluid;

FIG. 11a shows an enlarged section of FIG. 11;

FIG. 12a)-e) shows a rotor shaft with fluid lance of a rotor device according to the invention in a cross-sectional view in different variants of introduced impact protrusions with passage openings;

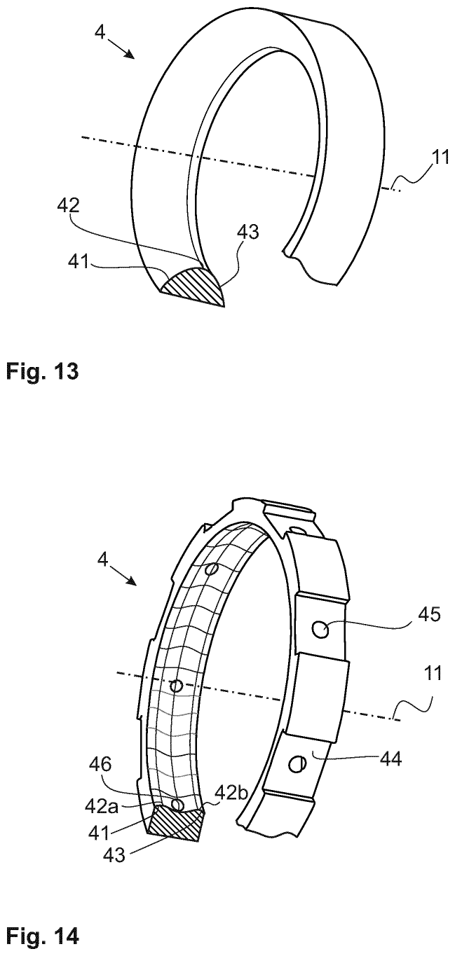

FIG. 13 shows an annular impact protrusion as a single part in a perspective view;

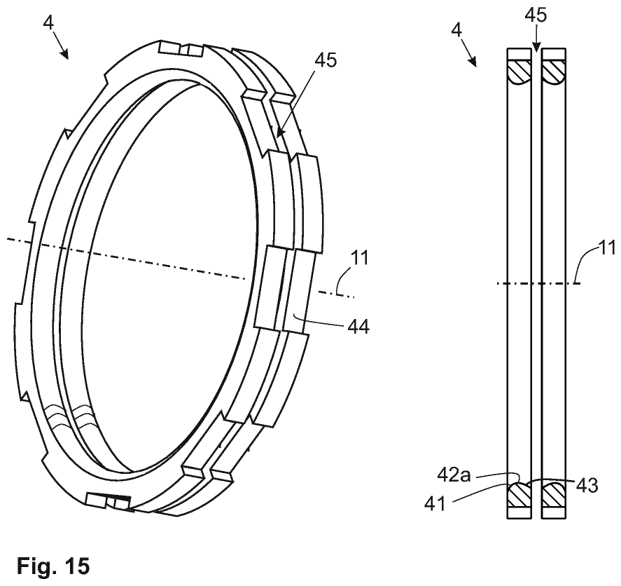

FIG. 14 shows an annular impact protrusion as a single part in a perspective view;

FIG. 15 shows an annular impact protrusion as installed from two mirror-symmetrical individual parts in a perspective view and a sectional view.

The following reference signs are used in the Figures
R rotor
S stator
1 rotor shaft
2 rotor core
3 fluid lance
4 impact protrusion
11 longitudinal axis
12 (a/b) inner wall
13 (a/b)fluid outflow opening
14 shaft shoulder
31 longitudinal axis
32 fluid outlet opening
41 rising flank
42 (a/b) peak
43 descending flank
44 bypass
45 radial channel
46 trough
121 rib

First, reference is made to FIG. 1.

A rotor device according to the invention essentially comprises a rotor R with a rotor shaft 1 and a rotor core 2. The rotor core 2 generally consists of a number of rotor laminations which are connected to the rotor shaft 1 in a non-rotating manner. The rotor shaft 1 is at least in portions a hollow shaft, preferably a hollow shaft. In addition, the rotor device according to the invention comprises a fluid lance 3 for cooling the inside of the rotor.

An electric machine according to the invention, in particular an electric motor, essentially comprises a stator S, as well as the rotor device according to the invention. The electric machine can in principle also be an electric generator.

The rotor shaft 1 is at least in portions a hollow shaft, preferably a hollow shaft. The rotor shaft has an axis of rotation or longitudinal axis 11. The rotor shaft 1 further has an inner wall 12.

The fluid lance 3 is essentially an elongated tube which is introduced laterally into the rotor shaft 1. Ideally, the longitudinal axis 31 of the fluid lance 3 extends in the longitudinal axis 11 of the hollow shaft 1. The fluid lance 3 is closed at one end, however, in the area of this end it is equipped with a radial fluid outlet opening 32, preferably a conical bore. The fluid outlet opening 32 is preferably designed with a throttling effect and/or has an additional throttling element. This allows the outlet speed of the cooling fluid to be increased.

The fluid lance 3 used here is preferably a stationary fluid lance. Due to this, the speed difference between the impact protrusion 4 and the fluid is higher than when a rotating fluid lance is used. However, it is also conceivable to use a co-rotating fluid lance.

According to the invention, it is provided that the inner wall 12 of the rotor shaft 1 is equipped with an impact protrusion 4. The impact protrusion 4 is basically designed as an elevation with respect to the inner wall 12. The impact protrusion 4 generally extends over the circumference of the inner wall. To that extent, the impact protrusion 4 is preferably designed as an annular elevation. With regard to its axial position, the impact protrusion 4 is arranged approximately in the center, preferably in the center of the rotor shaft 1. The impact protrusion divides the inner wall 12 to a certain extent into a first inner wall section 12a and a second inner wall section 12b.

Preferably, the impact protrusion 4 is designed as a separate part, in particular as a press-fit part. The impact protrusion 4 can thus be placed independently of other tolerance chains (e.g. in the case of rotor shafts assembled/rotation-welded from two half shafts; positioning tolerance of the fluid lance; etc.). The impact protrusion 4 can also be manufactured independently. The impact protrusion 4 is preferably made of material with good thermal conductivity, such as copper or aluminum. It is preferably introduced into the hollow shaft by thermal joining. FIG. 13, FIG. 14 and FIG. 15 show exemplarily an impact protrusion as a separate insert or press-fit part. In FIGS. 13 and 14, the impact protrusion is made as a one-piece ring, wherein the ring is sectioned for illustration purposes in order to show the cross-section. In FIG. 15, the impact protrusion is made of two identical but mirrored ring parts that are axially spaced apart from one another, wherein the spacing forms a continuous radial gap.

However, a one-piece configuration of the impact protrusion from the rotor shaft or two rotor half-shafts by a forming method of a hollow shaft blank such as hammering or forging is also conceivable.

Preferably, fluid discharge openings 13 are provided in the rotor shaft 1, in particular at the end but at least axially spaced apart from the impact protrusion 4. To that extent, a first fluid outflow opening 13a is provided in the region of the first axial end and a second fluid outflow opening 13b is provided in the region of the other axial end of the rotor shaft 1, or a first fluid outflow opening 13a is arranged in the first inner wall section 12a and a second fluid outflow opening 13b is arranged in the second inner wall section 12b. The fluid outflow openings 13 are preferably radial bores in the rotor shaft 1.

The basic operation of the rotor device according to the invention is as follows.

In a first variant, according to FIG. 1 or FIG. 13, for example, the impact protrusion 4 has a rising flank 41, a peak 42 and a descending flank 43 in the axial direction.

Cooling fluid flows into the fluid lance 3 and is directed out of the fluid outlet opening 32 in the direction of the impact protrusion 4. To prevent the formation of a spray mist, the cooling fluid is preferably discharged from the fluid lance as a compact fluid jet. The fluid outlet opening 32 of the fluid lance 3 is ideally positioned such that cooling fluid exiting here hits the peak 42 of the impact protrusion 4. The impact protrusion prevents or reduces a stagnant boundary layer: The fluid jet preferably hits the impact protrusion directly; it is not deflected by a boundary layer located above it.

The cooling jet preferably hits the surface of the impact protrusion perpendicularly.

Due to the constant fluid exchange in the highly turbulent wall flow in the impact area of the fluid flow of the fluid outlet opening 32 on the wall surface, the heat transfer between the cooling fluid and the hollow shaft or impact protrusion is increased.

To some extent, the fluid jet is divided by the impact protrusion 4 and a portion of the fluid flows off via the first inner wall section 12a towards the first fluid outflow opening 13a, while the other portion of the fluid flows off via the second inner wall portion 12b towards the second fluid outflow opening 13b.

Further preferred configurations of the rotor device according to the invention are, for example, designed as follows.

It can be provided, for example, that the rotor shaft of the rotor device is designed as an assembled and/or rotationally welded rotor shaft. It is essential here that the rotor shaft is composed of two parts, in particular a first rotor half-shaft 1a and a second rotor half-shaft 1b. This can, for example, facilitate the introduction or also shaping of the impact protrusion 4 in the center of the rotor shaft, for example if the impact protrusion 4 is introduced upstream of the rotor half-shafts 1a, 1b are connected.

An example of such an embodiment is shown in FIG. 3.

It may further be the case, for example, that the rotor device, in particular the rotor shaft R, is equipped with shaft shoulders 14. A shaft shoulder is a step between a larger rotor shaft inner diameter and a smaller rotor shaft inner diameter. The transition is not abrupt, but is designed over a transition region in which the diameter decreases. Preferably, a first shaft shoulder 14a is arranged between the impact protrusion 4 and the first fluid outflow opening 13a, in particular directly upstream of the first fluid outflow opening 13a, and a second shaft shoulder 14b is arranged between the impact protrusion 4 and the second fluid outflow opening 13b, in particular directly upstream of the second fluid outflow opening 13b. As a result, the hollow shaft forms a bathtub between each impact protrusion 4 and the respective fluid outflow opening. The shaft shoulders 14 act as a retaining dam. The thickness of the fluid film can be adjusted by the height of the shaft shoulders 14 above the inner wall 12. Furthermore, it is thus possible to delay the flow time of the cooling fluid so that the cooling fluid is prevented from flowing off too quickly and the heat absorption capacity of the cooling fluid can be better utilized. The fluid outflow openings 13, in particular their diameter or possible variances in different fluid outflow openings, are eliminated as an influencing factor for the outflow speed of the cooling fluid from the hollow shaft. The outflow speed of the cooling fluid is not changed by the shape of the fluid outflow openings. Furthermore, shaft shoulders 14 are preferable in the case of asymmetrically acting force components, in particular when cornering or when the rotor axis is tilted, since the fluid cannot flow off unhindered on one side, but rather abuts against a shaft shoulder 14a or 14b and an obliquely abutting fluid film is formed which extends over both half-sides 12a, 12b of the rotor inner wall. This effect is particularly important at low rotational speeds, especially <500/min, where the centripetal forces are not yet dominant and cannot force a uniform fluid film thickness. An example of such an embodiment is shown in FIG. 4.

It can be provided, for example, that the inner wall 12a or 12b is not designed to be smooth but structured. For example, axially extending ribs 121 can be considered as a structure. The ribs can be designed to be rectangular in cross-section. The grooves thus formed between two ribs can be designed to be rectangular. When the hollow shaft is unwound, the inner profile of the hollow shaft thus represents a continuous rectangular function. However, the ribs can also be of undulating shape in cross-section. The grooves can be correspondingly undulating in shape. When the hollow shaft is unwound, the contour of the inner profile of the hollow shaft then represents an approximately sinusoidal shape.

FIGS. 12a and 12e, respectively, can be used to illustrate rectangular or undulating ribs or grooves.

The ribs 121 have a surface-enlarging effect. The channels defined by the ribs 121 are designed, in particular in a technically preferred manner, in a spiral shape or, in a production-related preferred manner, in a straight line. Spiral-shaped channels have the advantage that the cooling fluid film is accelerated by the rotation, resulting in a defined fluid conveyance so that stagnant oil is effectively avoided. In the case of straight channels or smooth inner walls, displacement occurs primarily through the effort to form a fluid film that is as thin-walled and uniform as possible. The ribs 121 may be of uniform height or may rise axially outwards, thus, in the direction of the respective rotor shaft end, i.e. the groove depth increases. Uniform rib structures preferably start at an axial distance from the impact protrusion at which the fluid film has reached the greatest possible (e.g. >=90% of) shaft circumferential speed, in particular after sufficient equalization of the relative tangential speed between fluid and wall surface. Rising ribs can start axially closer to the impact protrusion, where there is still a larger difference between shaft circumferential speed and fluid film circumferential speed. Due to the longer distance, the fluid film then spills from one groove into the next in a thermally preferred manner until the relative speed has adapted as far as possible.

The inner wall of the shaft can also have microstructuring, e.g. by sandblasting or the introduction of small craters (dimples). The microstructuring can also be introduced, for example, in the form of an embossing process, in particular when the hollow shaft is manufactured by means of an internal mandrel.

Examples of such embodiments are shown in FIGS. 5 to 8, in particular constantly high ribs, without rise, starting at a distance from the impact protrusion in FIG. 5 and FIG. 6, respectively. Rising ribs with twist are shown in FIGS. 7 and 8, respectively, for example. Here, too, the ribs start with axial distance from the impact protrusion 4.

It may further be provided, for example, that a fluidic bypass 44 is provided between the first inner wall section 12a and the second inner wall section 12b or the resulting trough-shaped structure of shaft shoulder 14a, inner wall 12a and impact protrusion 4 on the one hand and impact protrusion 4 inner wall 12b and shaft shoulder 14b on the other hand. By fluidic bypass 44 is meant a fluidic connection which is not formed by the inner space of the impact protrusion 4 of annular shape. Rather, this refers to a fluidic connection formed by separate passage openings formed, for example, by grooves in the rotor shaft or the annular impact protrusion designed as a press-fit part. This can compensate for an initial uneven distribution of cooling fluid, since the cooling fluid strives to form a uniformly thick fluid film due to the circumferential forces caused by rotation. An uneven distribution can, for example, be the result of a non-center impact protrusion 4 or a centrifugal force-induced deflection of the exit jet during cornering.

An example of such an embodiment is shown in FIGS. 9 and 10, in FIG. 10 with the tilted position indicated.

It may further be provided, for example, that the impact protrusion 4 is provided with radially extending channels 45. This embodiment is generally only used if the above-mentioned fluidic bypass 44 is provided. The radially extending channels 45 then open into the axially extending bypass channels 44. A corresponding embodiment is shown in FIG. 14 in the form of a separate impact protrusion 4.

However, the radially extending channels 45 can also be designed as a continuous radial gap. In this case, the impact protrusion can be designed as a separate introduction part in the form of two identical but mirror-inverted ring parts to be introduced into the hollow shaft. The rings can be designed symmetrically or asymmetrically, however, the former simplifies assembly without misunderstanding, as the latter must be assembled directionally/mirrored. The axial spacing of the ring parts determines the width of the ring gap. The gap dimension between the rings positioned mirrored next to each other depends on the configuration of the oil jet from the lance and can be set accordingly with the spacer ring/disc. An embodiment with two respective axis-asymmetrical rings is shown in FIG. 15. However, two equally spaced rings, such as one shown in FIG. 13, could also be used, whereby a fluidic bypass (compensation channel) could be added as an outer circumferential groove in the rings themselves analogous to FIG. 14 or as an inner circumferential groove of the hollow rotor shaft analogous to FIG. 12a.

This can prevent the fluid from “stagnating” below the impact protrusion 4 in the fluidic bypass. A portion of the cooling fluid sprayed onto the impact protrusion 4 can directly enter the passage openings and thus directly reach the sections 12a or 12b of the inner wall. In this case, the diameter of the radial channels 45 is smaller than the fluid jet exiting the fluid lance 3 or its fluid outlet opening 31 or hitting the impact protrusion 4 so that the majority of the cooling fluid is deflected over the impact protrusion 4 to both sides. The radial channels 45 are formed such a depth that spray formation is prevented. The fluid jet hitting the axial bypass channels 44 is immediately forced to full circumferential speed by the side walls of the bypass channels 44, which shreds it. Since the spray has no room to spread, but immediately settles on the walls of the bypass channels 44 or is carried along by the following fluid stream, spray mist formation is effectively prevented.

Further preferred, the impact protrusion 4 can be designed with a trough 46 on the impact protrusion. Ultimately, the impact protrusion thus has a cross-section characterized by the following sequence along the longitudinal axis: a rising flank 41, a first peak 42a, a trough 46, a second peak 42b, and a descending flank 43. Due to this shape of the impact protrusion, the impinging cooling fluid is distributed approximately evenly to both sides even in the case of off-center impact. In particular, this can also reduce the influence of production-related positioning errors between the fluid lance and the impact protrusion. Embodiments according to the invention are shown, for example, in FIG. 11 or 14.

With regard to the production process of the rotor device according to the invention or the electric machine according to the invention, the following non-exhaustively listed production processes or process steps have proven to be particularly preferred.

The impact protrusion can be integrally designed with the shaft, e.g. hammered. The impact protrusion can be designed as a separate press-fit part.

The inner profile of the shaft or parts of the inner profile can be hammered. The inner profile can include the macrostructuring in the form of the inner wall, the impact protrusion, the ribs or grooves and shaft shoulders. Microstructuring (surface design or enlargement by means of craters, for example) can also be achieved by embossing or hammering.

The rotor shaft can be assembled, in particular from two half-shafts (rotationally) welded together. In particular, the half-shafts can be unequal so that the impact protrusion is completely formed in one half-shaft.

In summary, the following advantages or functions of the rotor device or electric machine according to the invention result in particular. The impact protrusion 4 divides the fluid flow symmetrically on the left and right sides. The center-symmetrical cooling division is largely insensitive to positional tolerances. Mounting the fluid lance slightly eccentrically, i.e. axially displaced relative to the center of the impact protrusion, is largely inconsequential.

The cooling also works properly when the vehicle is in a tilted position in which the rotor device or electric machine according to the invention is mounted, in particular when the vehicle is rotating about its longitudinal axis or cornering. The cooling works well even at low fluid pressure, because high exit speeds at the fluid lance are not necessary to penetrate a fluid film or boundary layer of the cooling fluid present at the point of impact. In particular, no standing fluid film can form due to the impact protrusion, so that a boundary layer of the cooling fluid is not present or is greatly reduced. As a result, the pressure of the cooling system can be lowered compared to the standard.

Typical application of the invention is the implementation in vehicles with at least one electric machine as drive.

Features and details which are described in connection with a method naturally also apply in connection with the device according to the invention and vice versa so that with regard to the disclosure concerning the individual aspects of the invention, reference is or can always be made mutually. In addition, a method according to the invention, if described, can be carried out with the device according to the invention.

1. Rotor device for an electric machine, comprising
a rotor with a rotor shaft and a rotor core, wherein
the rotor shaft is designed at least in portions as a hollow shaft with an inner wall, wherein
a fluid lance is inserted into the hollow shaft for cooling the inside of the rotor,
wherein the inner wall of the hollow shaft is equipped with an impact protrusion.

2. Rotor device according to claim 1, wherein the fluid lance is equipped with a radial fluid outlet opening, wherein the fluid outlet opening is directed towards the impact protrusion.

3. Rotor device according to claim 1, wherein the fluid lance is a stationary fluid lance.

4. Rotor device according to claim 1, wherein the impact protrusion divides the inner wall into a first inner wall section.

5. Rotor device according to claim 1, wherein a first fluid outflow opening is arranged in the first inner wall section and a second fluid outflow opening is arranged in the second inner wall section.

6. Rotor device according to claim 1, wherein the rotor shaft is designed as an assembled or rotationally welded rotor shaft comprising a first rotor half-shaft and a second rotor half-shaft.

7. Rotor device according to claim 1, wherein the inner wall of the rotor shaft is provided with shaft shoulders.

8. Rotor device according to claim 1, wherein the first inner wall section or the second inner wall section is structured with axially extending straight or spiral ribs, a microstructuring by sandblasting or small craters.

9. Rotor device according to claim 1, wherein the ribs, start at an axial distance from the impact protrusion at which the fluid film has reached >=90% shaft circumferential speed, wherein the ribs are designed to be uniformly high or to rise in the direction of the respective rotor shaft end.

10. Rotor device according to claim 1, wherein a fluidic bypass is provided between the first inner wall section and the second inner wall section, the resulting trough-shaped structure consisting of shaft shoulder inner wall, and impact protrusion on the one hand and impact protrusion inner wall, and shaft shoulder on the other hand.

11. Rotor device according to claim 1, wherein the fluidic bypass is formed by grooves in the rotor shaft or the annular impact protrusion designed as a separate part.

12. Rotor device according to claim 1, wherein the impact protrusion is provided with radially extending channels, wherein the channels end in particular in the fluidic bypass.

13. Rotor device according to claim 1, wherein the impact protrusion is formed in one piece with the rotor shaft.

14. Rotor device according to claim 1, wherein the impact protrusion has a rising flank, a peak and a descending flank in the axial direction or a rising flank, a first peak, a trough, a second peak, and a descending flank.

15. Electric machine, in particular electric motor, comprising a stator and a rotor device according to claim 1.

16. Rotor device according to claim 1, wherein the fluid lance is equipped with a conical bore, wherein the conical bore is directed towards the impact protrusion.

17. Rotor device according to claim 5, wherein the inner wall of the rotor shaft is provided with a first shaft shoulder between the impact protrusion and the first fluid outflow opening, and a second shaft shoulder between the impact protrusion and the second fluid outflow opening

18. Rotor device according to claim 18, wherein a first shaft shoulder is directly upstream of the first fluid outflow opening, a second shaft shoulder is directly upstream of the second fluid outflow opening.

19. Rotor device according to claim 1, wherein the impact protrusion is a separate part from the rotor shaft, as a ring made of a material with good thermal conductivity

20. Rotor device according to claim 19, wherein the ring is made of aluminum or copper.
